(19) United States
(12) Patent Application Publication
(10) Pub. No.: US 2025/0025966 A1
(43) Pub. Date: Jan. 23, 2025

(54) METHODS FOR PROVIDING CORROSION PROTECTION TO PROCESS VESSELS AND CORROSION PROTECTED PROCESS VESSELS OBTAINED THEREBY

(71) Applicant: INTEGRATED GLOBAL SERVICES, INC., Richmond (VA)

(72) Inventors: Norman A. KIDDIE, Richmond, VA (US); Ian M. KIDDIE, Richmond, VA (US); Johan VAN WYK, Richmond, VA (US); Teresa N. HUYSAMEN, Richmond, VA (US)

(21) Appl. No.: 18/775,250

(22) Filed: Jul. 17, 2024

Related U.S. Application Data
(60) Provisional application No. 63/514,201, filed on Jul. 18, 2023.

(51) Int. Cl. B23K 31/02

(52) U.S. Cl. CPC B23K 31/02

(57) ABSTRACT

Corrosion protection is provided to an interior surface of a process vessel by welding a metal band to the interior surface of the process vessel while first and second metal overlay sections are joined to the interior surface of the process vessel such that opposed end regions of the first and second overlay sections are adjacent to one another and are positioned over the metal band. A weld line section is formed by welding the opposed end regions of the overly sections to one another and to the metal band. The weld line section is then covered with a metal seal strip which is itself welded to each of the opposed end regions of the overlay sections.

### CROSS-REFERENCE TO RELATED APPLICATION

This application is related to and claims domestic priority benefits from U.S. Provisional Application Ser. No. 63/514,201 filed on Jul. 18, 2023, the entire contents of which are expressly incorporated hereinto by reference.

### FIELD

The embodiments disclosed herein relate generally to methods by which process vessels (e.g., pressure vessels used in corrosive application, autoclaves used in the mineral industry, tanks which hold corrosive media and the like) may be protected against corrosion. In especially preferred forms, the embodiments disclosed herein relate to methods for providing corrosion protection to process vessels utilizing a combination of plate lining and corrosion-resistant overlays that provide multiple layers of protection to prevent failures from occurring.

### BACKGROUND

It is known in the art that process vessels employed in corrosive environments having vessel walls and components formed of carbon steel must be protected by corrosion-resistant materials. For example, it is known that autoclaves constructed of carbon steel, experience significant corrosion that can destroy the vessel in a short time span if no corrosion-resistant measures are taken. Conventional methods to provide corrosion resistance to autoclaves include acid brick refractory/lining, composition linings, lead linings and combinations thereof. Such linings (coatings) are typically applied during manufacture of the autoclave. It can be quite challenging to repair damage to the autoclave linings (coatings) through use, especially if the autoclave cannot be rotated. Such repair methods are quite time consuming and limited in nature to perform a quality repair.

Plate lining of process vessels has also been practiced. However, conventional plate lining techniques to provide corrosion resistant to process vessels will usually experience cracking at the edges due to the different types of metals being welded (e.g., the carbon steel of the vessel components on the one hand and the corrosion resistant (stainless) steel of the plate linings on the other hand). When cracking occurs, the corrosive media can penetrate to the carbon steel walls of the process vessel causing rapid corrosion and vessel destruction.

It would therefore be highly desirable if improvements to providing corrosion protection to process vessels could be provided which minimizes (if not overcomes entirely) the disadvantages of conventional techniques for protecting process vessels against corrosion. It is towards providing such a need that the embodiments disclosed herein are directed.

### SUMMARY

In general the embodiments disclosed herein are directed toward methods to provide corrosion protection to an interior surface of a process vessel. In preferred embodiments, a metal band may be welded to the interior surface of the process vessel while first and second metal overlay sections are joined to the interior surface of the process vessel such that opposed end regions of the first and second overlay sections are adjacent to one another and are positioned over the metal band. A weld line section is formed by welding the opposed end regions of the overly sections to one another and to the metal band. The weld line section is then covered with a metal seal strip which is itself welded to each of the opposed end regions of the overlay sections.

The overlay sections may be jointed to the interior vessel surface by drilling apertures therethrough and then welding the overlay sections to the interior vessel surface by plug welds. The resulting plug welds may also be covered to provide corrosion protection with respective seal plates welded to adjacent regions of the overlay sections.

According to certain embodiments, the metal band is an annular metal band that is joined to a lower end of a nozzle neck of the process vessel. The first overlay section may therefore be welded to an interior surface of a pressure vessel wall adjacent to lower end of the nozzle neck while the second overlay section may be a nozzle liner which lines an interior surface region of the nozzle neck such that the opposed end regions of the first and second overlay sections are substantially at right angles relative to one another. According to some embodiments, the end region of the nozzle liner may include an extended portion which extends into the interior of the process vessel by a predetermined distance. A right angle metal strip may thus be welded to the end region of the first overlay section and an adjacent extended portion of the nozzle liner.

The metal band, the metal overlay sections and the metal seal plate are most preferably formed of the same corrosion-resistant metal, such as a nickel-based alloy (e.g., INCONEL® 625 alloy).

These and other aspects and advantages of the present invention will become more clear after careful consideration is given to the following detailed description of the preferred exemplary embodiments thereof.

### BRIEF DESCRIPTION OF ACCOMPANYING DRAWINGS

The disclosed embodiments of the present invention will be better and more completely understood by referring to the following detailed description of exemplary non-limiting illustrative embodiments in conjunction with the drawings of which:

FIG. 1 is a partial exterior perspective view of an exemplary process vessel that may be corrosion-protected according to the embodiments disclosed herein;

FIG. 2 is an enlarged cross-sectional elevational view of a portion of the vessel wall as taken along lines 2-2 in FIG. 1;

FIGS. 2A-2D are enlarged cross-sectional views showing the sequence by which corrosion protection according to an embodiment of the present invention is provided to the interior surfaces of the vessel wall;

FIG. 3 is a cross-sectional view of a vessel wall showing another embodiment of the present invention to provide corrosion protection to the interior surface thereof;

FIG. 3A is an enlarged portion of the vessel wall shown in FIG. 3;

FIG. 4 is an enlarged cross-section elevation view of a portion of the vessel nozzle as taken along lines 4-4 in FIG. 1; and

FIGS. 4A-4C are enlarged cross-sectional views showing the sequence by which corrosion protection according to an embodiment of the present invention is provided to the interior surfaces of the vessel nozzle.

### DETAILED DESCRIPTION OF EMBODIMENTS

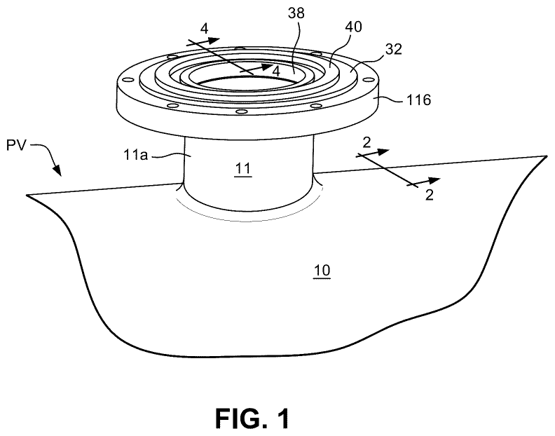

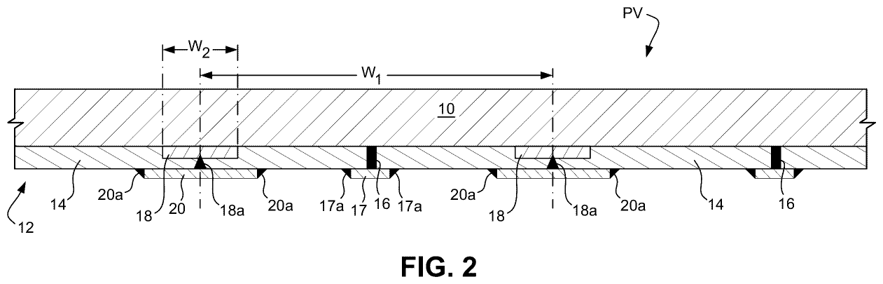

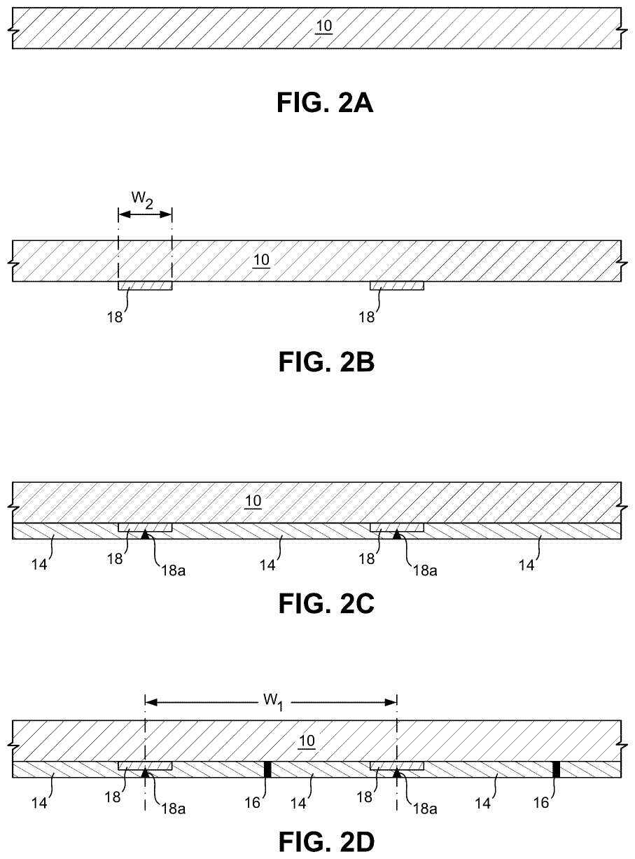

As is schematically shown in FIG. 1, a process vessel PV may be provided with a vessel wall 10 and a vessel nozzle 10a. The vessel wall 10 is perhaps better shown in FIG. 2 and is typically formed from a carbon steel material of sufficient thickness to comply with its intended purpose. As is shown more specifically in FIG. 2, the interior surface of the vessel wall 10 includes a corrosion-protective assembly 12 comprised of abutted corrosion resistant metal overlay sections 14 having a sufficient widthwise dimension W1 of typically between about 0.75 meters to about 10 meters (+/−). The overlay sections 14 may be any thickness as may be needed for the desired corrosion resistance, e.g., between about 5 mm to about 10 mm, typically about 6 mm (+/−). The overlay sections 14 are rigidly joined to the interior surfaces of the vessel wall 10 by plug welds 16 through drilled apertures in the overlay sections 14 located between the lateral side edges thereof. The plug welds 16 may be covered by suitably dimensioned seal plates 17 having a nominal thickness of 1 mm to about 10 mm (+/−) which are welded to a respective subjacent portion of the underlying corrosion resistant overlay sections 14 by weld lines 17a.

Corrosion resistant metal bands 18 typically having a widthwise dimension W2 of between about 25 mm to about 75 mm (+/−) and a thickness between about 3 mm to about 6 mm (+/−) may be welded to the subjacent interior surfaces of the vessel wall 10 at spaced apart locations corresponding to the abutted edge junctions of adjacent overlay sections 14. The opposed edges of the abutted adjacent overlay sections 14 may thus in turn be butt welded to one another and to a respective underlying metal band 18 as shown by the weld lines 18a in FIG. 2. Seal strips 20 having a nominal thickness of 1 mm to about 10 mm (+/−) may thereafter be placed in covering relationship over the weld lines 18a and welded at their respective edges to the subjacent overlay sections 14 via weld lines 20a.

Each of the overlay sections 14, seal plates 17, metal bands 18 and seal strips 20 is preferably formed from the same corrosion resistant metal alloy, for example, a nickel-based alloy, such as INCONEL® 625 nickel-chromium alloy, fabricated from a rolled metal sheet having suitable thicknesses as described briefly above.

The method to provide corrosion resistance to the vessel wall 10 is shown schematically by FIGS. 2A-2D. Specifically, as shown in FIG. 2A, the interior surface of the vessel wall 10 may be prepared to receive the corrosion-protective assembly 12 by suitable cleaning, e.g., chemical cleaning, sand blasting or the like. Thereafter, the metal bands 18 may be welded to the interior surface of the vessel wall 10 as shown in FIG. 2B. The overlay sections 14 may then be applied onto the interior surface of the vessel wall 10 such that abutted edges of adjacent overly sections 14 are positioned over the metal bands 18 whereby they may be welded to one another and to the subjacent metal bands 18 via the weld lines 18a as shown in FIG. 2C. As shown in FIG. 2D, apertures may thereafter be drilled through the overlay sections 14 at locations between the opposed edges thereof to allow the overlay sections 14 to be rigidly joined to the vessel wall 10 via the plug welds 16 filling the drilled apertures. Thereafter, the seal strips 20 may be placed in covering relationship over the weld lines 18a and welded at their respective edges to the subjacent overlay sections 14 via weld lines 20a in order to complete the corrosion-protective assembly 12 as shown in FIG. 2.

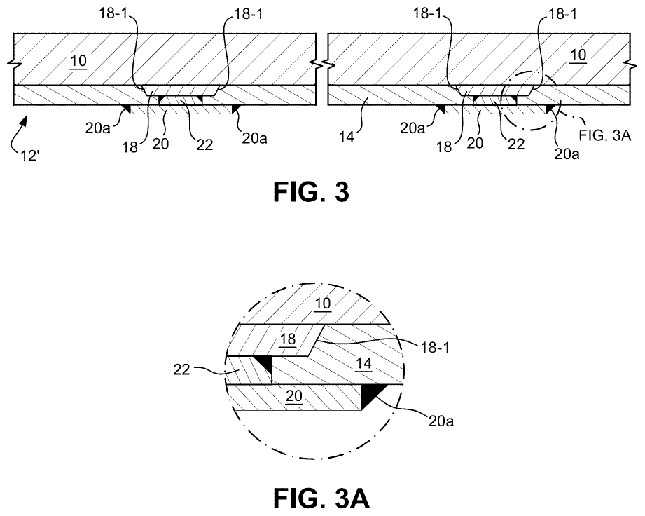

An alternative embodiment of a corrosion-protective assembly 12′ is shown in FIGS. 3 and 3A as including the same structural components as employed in the embodiment of the corrosion-protective assembly 12 depicted in FIG. 12. According to the embodiment of the corrosion-protective assembly 12′ shown in FIGS. 3 and 3A, however, the side edges of the overlay sections 14 may be beveled/angled (e.g., by abrasion and/or machining) so as to conform to the beveled/angled opposed edges of the metal bands 18a. Further, a fillet weld 22 will be formed to join the abutted side edges of the overlay sections 14 to one another and to the subjacent metal band 18. The fillet weld 22 will thereby be protectively covered by the seal strips 20 which are welded at their respective edges to the subjacent overlay sections 14 via weld lines 20a as was previously described.

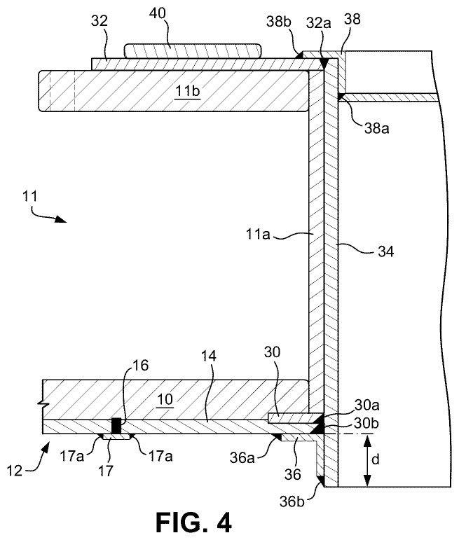

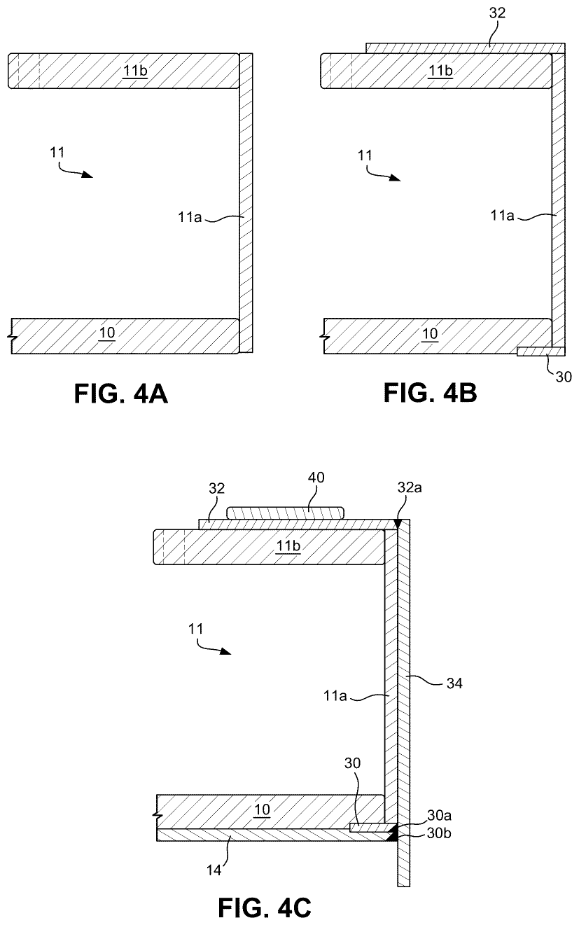

An embodiment of the present invention which is especially adapted to providing corrosion protection to the interior of vessel nozzle 11 by a corrosion-protective assembly 12″ is shown in accompanying FIG. 4. As is shown, the vessel nozzle 11 will include a cylindrical neck 11a that is joined at its lower end by welding to the vessel wall 10 and at its upper end to a nozzle flange 11b. An annular protective metal band 30 formed of a corrosion-resistant metal alloy is welded to the juncture between the lower end of the neck 11a and the vessel wall 10. Similarly an annular protective metal band 32 is joined via welding to the upper surface of the nozzle flange 11b. A cylindrical corrosion-protective nozzle liner 34 is positioned on the interior surface of the nozzle neck 11b and welded to the adjacent ends of the annular metal band 30 and the protective overlay 14 by weld lines 30a and 30b, respectively, and at its lower end and to the adjacent end of the annular metal band 32 at its upper end by weld line 32a.

As is shown in FIG. 4, the cylindrical corrosion-protective nozzle liner 34 has a sufficient lengthwise dimension so as to extend a distance (d) beyond the overlay section 14 and into the interior of the vessel PV so that the end region of the overlay section 14 and the extended end of the nozzle liner 34 are substantially at a right angle relative to one another. An interior right annular angle seal 36 is welded via weld lines 36a, 36b to the protective overlay 14 and the extension portion of the liner 34, respectively. Similarly, an exterior annular right angle seal 38 is welded via weld lines 38a, 38b to an upper interior region of the liner 34 and the annular metal band 32, respectively. An annular raised face plate 40 may also be welded to the annular metal band 32 and shaped (e.g., by machining) so as to provide a conventional ASME B116.5 flange face or equivalent.

As in the embodiment described above with reference to FIG. 2, each of the annular protective metal bands 30 and 32 and the interior and exterior annular angle seals 36, 38, respectively, is preferably formed from the same corrosion resistant metal alloy, for example, a nickel-based alloy, such as INCONEL® 625 alloy of suitable thicknesses e.g., between about 1 mm to about 10 mm (+/−).

The method to provide corrosion resistance to the vessel nozzle 11 is shown schematically by FIGS. 4A-4C. Specifically, as shown in FIG. 4A, the interior surfaces of the nozzle neck 11a and upper surface of the nozzle flange 11b may be prepared to receive the corrosion-protective assembly 12″ by suitable cleaning, e.g., chemical cleaning, sand blasting or the like. Thereafter, the annular protective metal bands 30, 32 may be welded to the interior surface of the vessel wall 10 and the upper surface of the nozzle flange 12b as shown in FIG. 4B. It will be observed in this regard that the surfaces of the interior surface of the vessel wall 10 and the lower edge of the nozzle neck 11b may be machined so as to form a recessed region for receiving the annular band 30.

As is shown in FIG. 4C, a protective overlay 14 may then be applied onto the interior surface of the vessel wall 10 via the plug welds 16 and covered with the seal plates 17 such that a terminal end region of the overlay 14 is positioned over the annular metal band 30. At this time, the nozzle liner 34 may be joined by welding at weld lines 30a, 30b and 32a to each of the annular edges defined by the annular band 30, the protective overlay 14 and the annular band 32, respectively. In addition, the annular raised face plate 40 may also be welded to the annular metal band 32 and shaped to provide the flange face. The interior and exterior annular angle seals 36, 38 may thereafter be welded to the protective overlay 14 and the lower extension portion of the liner 34 via the weld lines 36a, 36b and to an upper interior region of the liner 34 and the annular metal band 32 so as to achieve the corrosion-protective assembly 12″ as shown in FIG. 4.

While reference has been made to particular embodiments of the invention, various modifications within the skill of those in the art may be envisioned. Therefore, it is to be understood that the invention is not to be limited to the disclosed embodiments, but on the contrary, is intended to cover various modifications and equivalent arrangements included within the spirit and scope thereof.

What is claimed is:

1. A method to provide corrosion protection to an interior surface of a process vessel comprising:
(i) welding a metal band to the interior surface of the process vessel;
(ii) joining first and second metal overlay sections to the interior surface of the process vessel such that opposed end regions of the first and second overlay sections are adjacent to one another and are positioned over the metal band;
(iii) forming a weld line section by welding the opposed end regions of the overlay sections to one another and to the metal band; and
(iv) covering the weld line section with a metal seal strip and welding the metal seal strip to each of the opposed end regions of the overlay sections.

2. The method according to claim 1, wherein step (ii) comprises the steps of:
(iia) drilling apertures through the overlay sections; and
(iib) welding the overlay sections to the interior surface of the process vessel by plug welds in the apertures.

3. The method according to claim 4, further comprising the step of:
(iic) covering the plug welds with a seal plate and welding the seal plate to adjacent regions of the overlay sections.

4. The method according to claim 1, wherein
the metal band is an annular metal band that is joined to a lower end of a nozzle neck of the process vessel, and wherein
the first overlay section is welded to an interior surface of a pressure vessel wall adjacent to lower end of the nozzle neck, and wherein
the second overlay section is a nozzle liner which lines an interior surface region of the nozzle neck such that the opposed end regions of the first and second overlay sections are substantially at right angles relative to one another.

5. The method according to claim 10, wherein the end region of the nozzle liner includes an extended portion which extends into an interior of the process vessel by a predetermined distance.

6. The method according to claim 11, wherein the metal seal strip is a right angle metal strip welded to the end region of the first overlay section and an adjacent extended portion of the nozzle liner.

7. The method according to claim 1, wherein the metal band, the metal overlay sections and the metal seal plate are formed of the same corrosion-resistant metal.

8. The method according to claim 7, wherein the corrosion-resistant metal is a nickel-based alloy.

9. The method according to claim 1, which further comprises forming beveled surfaces on metal band and/or the opposed end regions of the first and second overlay sections.

10. The method according to claim 8, wherein the corrosion-resistant nickel-based alloy is Inconel 625 alloy.

11. A process vessel having a corrosion-protection assembly on an interior surface of the process vessel, wherein the corrosion-protection assembly comprises:
a metal band welded to the interior surface of the process vessel;
first and second metal overlay sections joined to the interior surface of the process vessel such that opposed end regions of the first and second overlay sections are adjacent to one another and are positioned over the metal band;
a weld line section formed by welding the opposed end regions of the overlay sections to one another and to the metal band; and
a metal seal strip covering the weld line and being welded to each of the opposed end regions of the overlay sections.

12. The process vessel according to claim 11, wherein the corrosion-protection assembly further comprises:
apertures drilled through the overlay sections; and
plug welds in the apertures to weld the overlay sections to the interior surface of the process vessel.

13. The process vessel according to claim 12, wherein the corrosion-protection assembly further comprises seal plates covering respective ones of the plug welds and being welded to adjacent regions of the overlay sections.

14. The process vessel according to claim 11, wherein
the metal band is an annular metal band that is joined to a lower end of a nozzle neck of the process vessel, and wherein
the first overlay section is welded to an interior surface of a pressure vessel wall adjacent to lower end of the nozzle neck, and wherein
the second overlay section is a nozzle liner which lines an interior surface region of the nozzle neck such that the opposed end regions of the first and second overlay sections are substantially at right angles relative to one another.

15. The process vessel according to claim 14, wherein the end region of the nozzle liner includes an extended portion which extends into an interior of the process vessel by a predetermined distance.

16. The process vessel according to claim 15, wherein the metal seal strip is a right angle metal strip welded to the end region of the first overlay section and an adjacent extended portion of the nozzle liner.

17. The method according to claim 11, wherein the metal band and/or the opposed end regions of the first and second overlay sections include beveled surfaces.

18. The process vessel according to claim 11, wherein the metal band, the metal overlay sections and the metal seal plate are formed of the same corrosion-resistant metal.

19. The process vessel according to claim 18, wherein the corrosion-resistant metal is a nickel-based alloy.

20. The process vessel according to claim 19, wherein the corrosion-resistant nickel-based alloy is Inconel 625 alloy.
